(19) United States
(12) Patent Application Publication
(10) Pub. No.: US 2014/0029140 A1
(43) Pub. Date: Jan. 30, 2014

(54) ACTUATOR ARM WITH A SHELF AND CUTOUT

(71) Applicants: Roger A. Resh, Prior Lake, MN (US); Daniel D. Dittmer, Shakopee, MN (US)

(72) Inventors: Roger A. Resh, Prior Lake, MN (US); Daniel D. Dittmer, Shakopee, MN (US)

(73) Assignee: Seagate Technology LLC

(21) Appl. No.: 13/556,289

(22) Filed: Jul. 24, 2012

(51) Int. Cl. G11B 21/24

(52) U.S. Cl. 360/294; G9B/21.028

(57) ABSTRACT

In certain embodiments, an actuator arm has a shelf overlapping a coil region. The shelf defines at least one cutout over the coil region.

In certain embodiments, an actuator arm includes a shelf and a coil. The shelf extends over the coil and forms at least one cutout along a rim of the shelf.

### SUMMARY

In certain embodiments, an actuator arm has a shelf overlapping a coil region. The shelf defines at least one cutout over the coil region.

In certain embodiments, an actuator arm includes a shelf and an attached coil. The shelf extends over the coil and forms at least one cutout along a rim of the shelf.

### BRIEF DESCRIPTION OF THE DRAWINGS

FIG. 1 provides an exploded, perspective view of a data storage device, in accordance with certain embodiments of the present disclosure.

FIG. 2 provides a top view of an actuator arm, in accordance with certain embodiments of the present disclosure.

FIG. 3 provides a perspective view of an actuator arm, in accordance with certain embodiments of the present disclosure.

FIG. 4 provides a side view of an actuator arm, in accordance with certain embodiments of the present disclosure.

FIG. 5 provides a perspective view of an actuator arm, in accordance with certain embodiments of the present disclosure.

FIG. 6 provides a perspective view of an actuator arm, in accordance with certain embodiments of the present disclosure.

FIG. 7 provides a side view of an actuator arm, in accordance with certain embodiments of the present disclosure.

FIG. 8 provides a perspective view of an actuator arm, in accordance with certain embodiments of the present disclosure.

FIG. 9 provides a perspective view of an actuator arm, in accordance with certain embodiments of the present disclosure.

### DETAILED DESCRIPTION

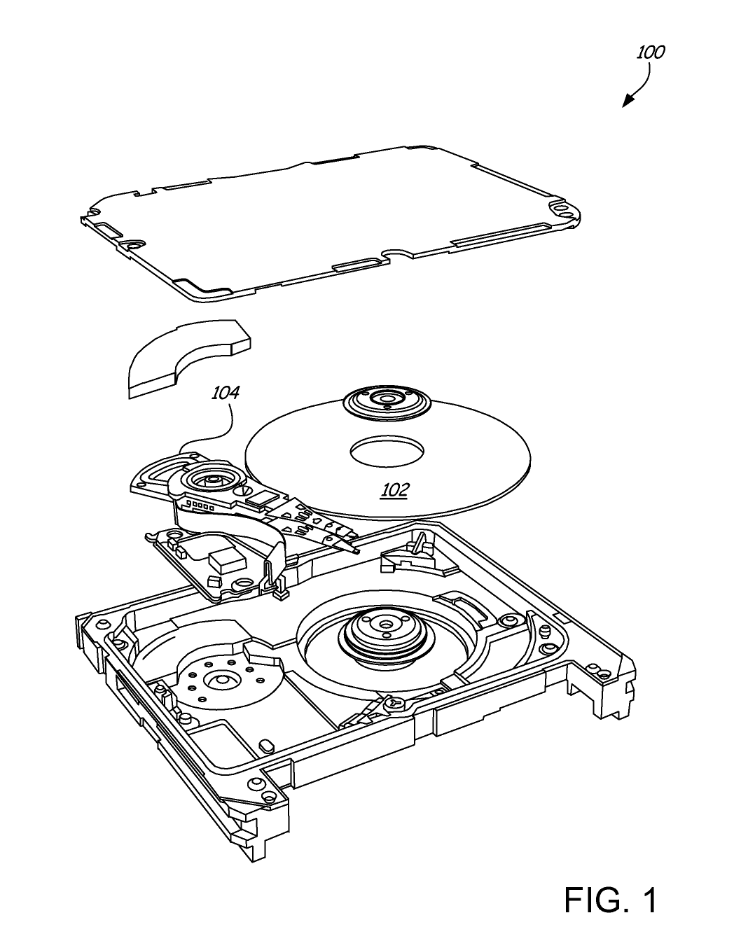

The present disclosure relates to devices for reducing actuator arm vibration. As shown in FIG. 1, a data storage device 100 can be provisioned with recording media 102 for storing data. An actuator arm 104 pivots to move read/write heads across the recording media 102 to store and retrieve data. Attached to the actuator arm 104 is a coil that interacts with magnets to move the actuator arm 104. During operation, the coil generates heat that can affect performance of the data storage device. Further, when pivoting from one position to another, the actuator arm 104 can vibrate due to an actuator arm's structural asymmetry. Actuator arm vibration can also affect performance of the data storage device 100. Certain embodiments of the present disclosure are accordingly directed to devices for reducing actuator arm vibration and/or coil temperatures.

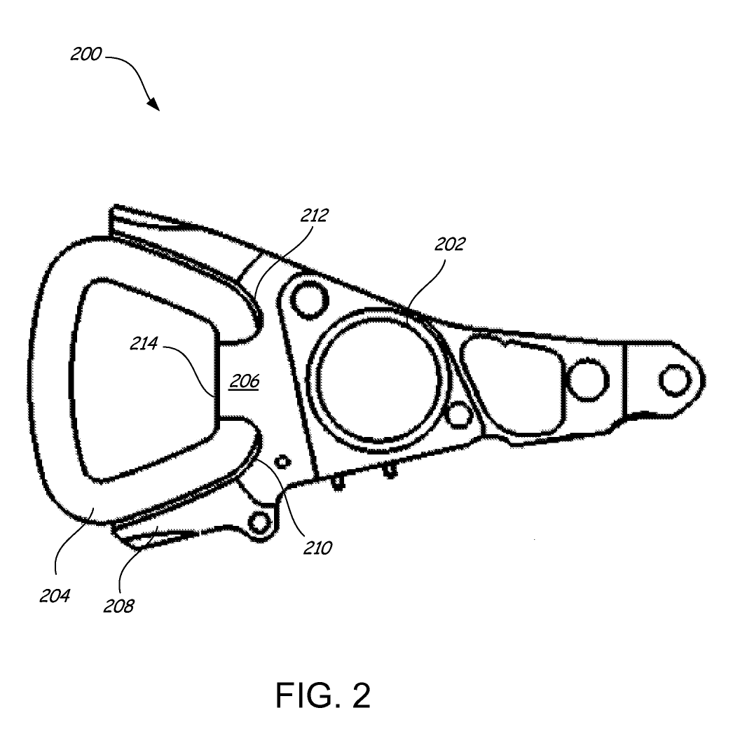

FIGS. 2-4 provide different views of an actuator arm 200 including a pivot bore 202, coil 204 (only shown in FIG. 2), and shelf 206. The coil 204 may be attached to the actuator arm 200 at a yoke portion 208, which is sometimes called a yoke because of its shape. The shelf 206 overlaps at least a portion of the coil 204 and can be positioned above or below the coil 204. In the case where a coil is not yet present, the shelf 206 overlaps at least a portion of a coil region, where a coil may eventually be attached to an actuator arm. As shown in FIG. 2, the shelf 206 may be substantially symmetric in shape.

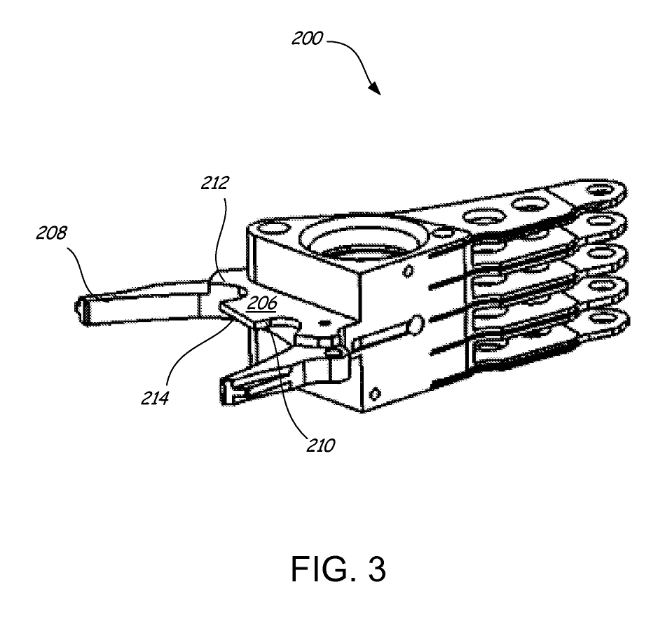

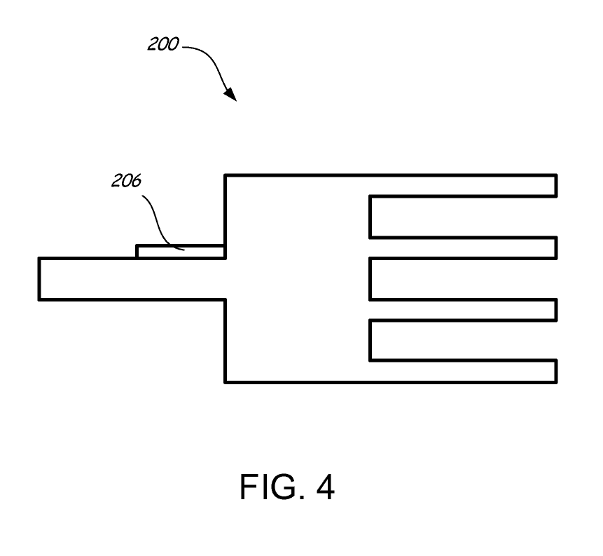

During operation, current is passed through the coil 204 to energize the coil 204, which interacts with magnets to actuate the actuator arm 200. The energized coil 204 generates heat—a portion of which is absorbed by the shelf 206 acting as a heat sink. The shelf 206 features at least one cutout over the coil 204 or coil region. In FIGS. 2 and 3, the shelf 206 defines two cutouts 210, 212 along a rim 214 of the shelf 206. The shelf 206 with cutouts 210, 212 reduces structural asymmetry in the actuator arm 200. This reduction mitigates actuator arm vibration during actuation, for example, when pivoting from one data storage track to another. An actuator arm's structural asymmetry can differ from design to design. As such, using an actuator arm design with two shelf cutouts instead of one depends on, among other things, the design of the rest of the actuator arm and its structural response to excitations. FIG. 4 shows a side view of actuator arm 200, which is sometimes referred to as an E-block because of its profile.

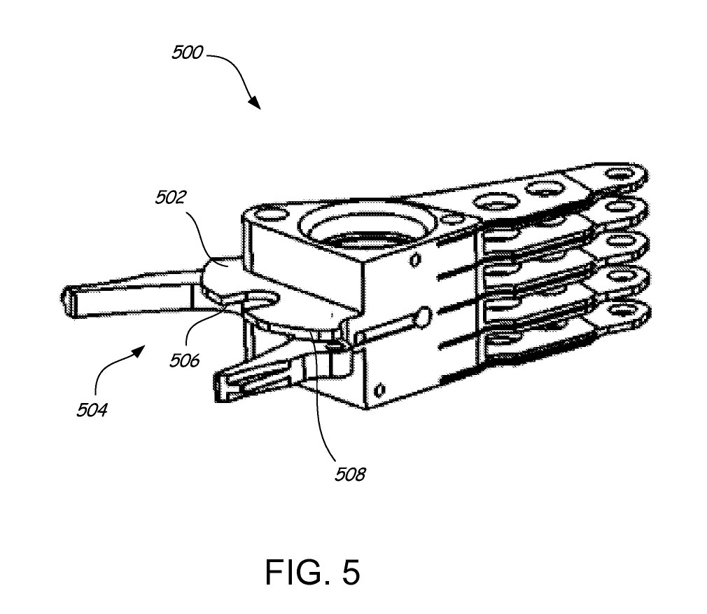

FIG. 5 provides a perspective view of an actuator arm 500 including a shelf 502 overlapping at least a portion of a coil region 504. The shelf 502 includes a cutout 506 along a rim 508 of the shelf 502. As with other embodiments of the present disclosure, the cutout shelf 502 reduces the actuator arm's structural asymmetry while also acting as a heat sink. Further, the shelf 502 may be substantially symmetric in shape.

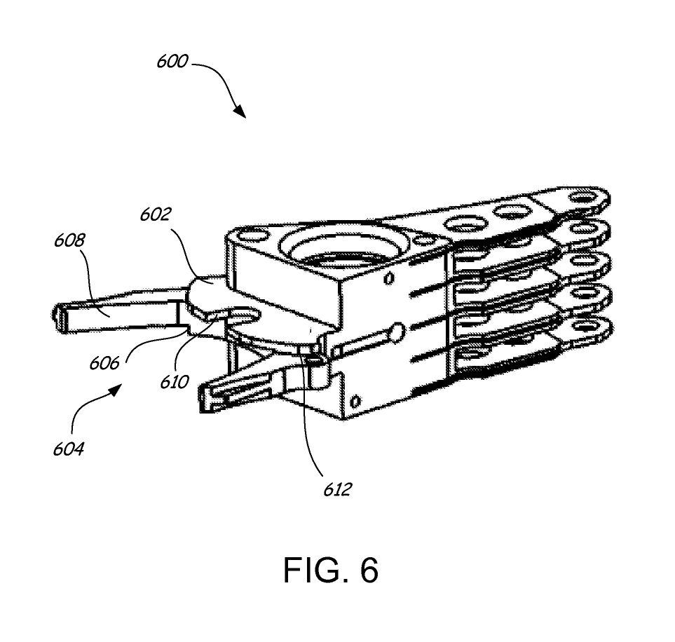

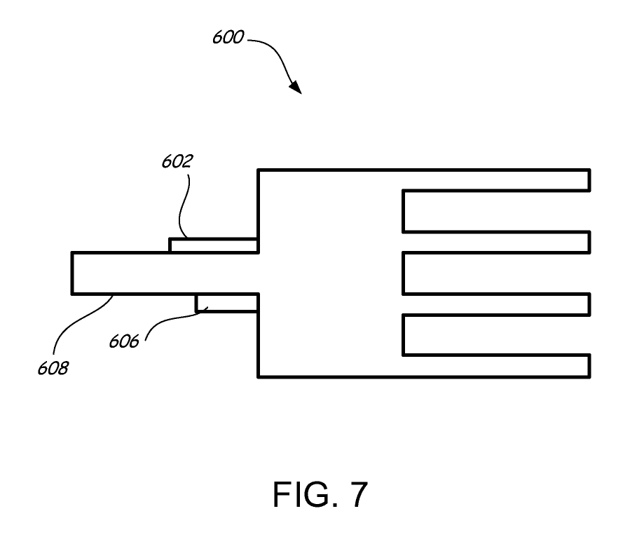

FIGS. 6 and 7 provide views of an actuator arm 600 including a shelf 602 overlapping at least a portion of a coil region 604. The actuator arm 600 also has a stiffening step 606 on the bottom side of yoke portion 608 to further reduce the actuator arm's structural asymmetry. The shelf 602 defines a cutout 610 along a rim 612 of the shelf 602.

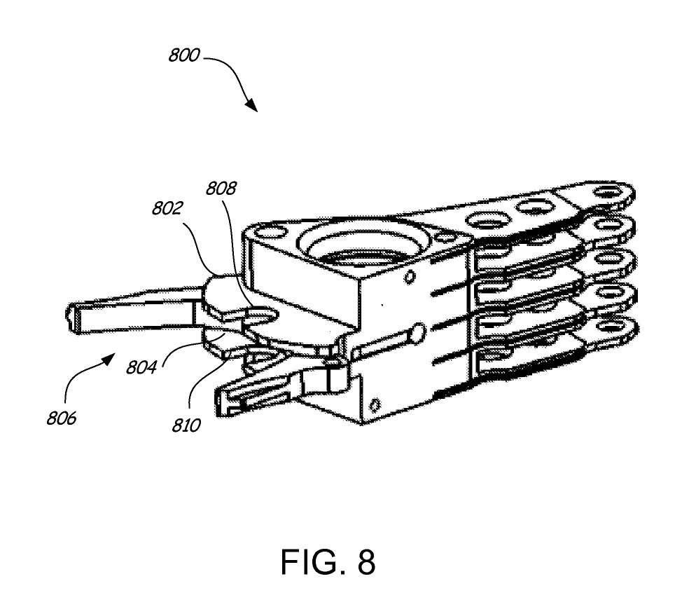

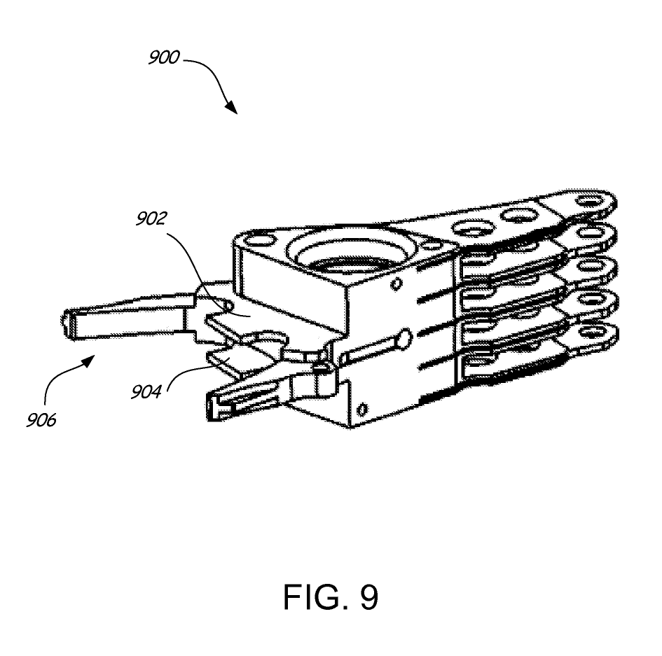

FIG. 8 provides a perspective view of an actuator arm 800 including a first shelf 802 and a second shelf 804, both overlapping at least a portion of a coil region 806. The first shelf 802 and second shelf 804 are positioned on opposite sides of the coil region 806. Both shelves 802, 804 include a cutout 808, 810. FIG. 9 similarly provides a perspective view of an actuator arm 900 including a first shelf 902 and a second shelf 904 positioned on opposite sides of a coil region 906. Here, both shelves 902, 904 have two cutouts.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. An apparatus comprising:
an actuator arm having a shelf overlapping at least a portion coil region, wherein the shelf defines at least one cutout over the coil region.

2. The apparatus of claim 1, wherein the shelf is positioned above the coil region.

3. The apparatus of claim 1, wherein the shelf is positioned below the coil region.

4. The apparatus of claim 1, wherein the actuator arm further includes a second shelf overlapping at least a portion of the coil region.

5. The apparatus of claim 4, wherein the second shelf is positioned on an opposite side of the coil region as the other shelf.

6. The apparatus of claim 1, wherein the shelf defines the at least one cutout along a rim of the shelf.

7. The apparatus of claim 1, wherein the shelf defines two cutouts over the coil region.

8. The apparatus of claim 7, wherein the shelf defines a symmetric shape.

9. The apparatus of claim 1, further comprising:
a coil positioned within the coil region.

10. The apparatus of claim 9, wherein the shelf is configured to cool the coil.

11. The apparatus of claim 1, wherein the shelf is configured to provide structural symmetry to the actuator arm.

12. An actuator arm comprising:
a shelf and a coil, wherein the shelf extends over at least a portion of the coil and forms at least one cutout along a rim of the shelf.

13. The actuator arm of claim 12, wherein shelf defines two cutouts.

14. The actuator arm of claim 12, further comprising:
a second shelf extending over at least a portion of the coil.

15. The actuator arm of claim 14, wherein the second shelf defines a cutout along a rim of the second shelf.

16. The actuator arm of claim 12, further comprising:
a step on an opposite side of the coil as the shelf.

17. The actuator arm of claim 12, wherein the shelf forms a symmetric shape.
